(19) United States
(12) Patent Application Publication
(10) Pub. No.: US 2019/0207427 A1
(43) Pub. Date: Jul. 4, 2019

(54) METHODS AND APPARATUSES FOR POWERING ELECTRICAL SYSTEMS ONBOARD CARTS

(71) Applicant: Blynk Technology, Portland, ME (US)

(72) Inventors: Allegra A. McNeally, Scarborough, ME (US); Shahzad Kirmani, Scarborough, ME (US); Daniel Shahzad Kirmani, Scarborough, ME (US)

(21) Appl. No.: 16/235,165

(22) Filed: Dec. 28, 2018

Related U.S. Application Data
(60) Provisional application No. 62/612,485, filed on Dec. 31, 2017.

(51) Int. Cl. H02J 50/12; B62B 5/00; H02J 7/00; A47F 10/04; H02J 7/35

(52) U.S. Cl. CPC H02J 50/12; B62B 5/00; H02J 7/35; A47F 10/04; H02J 7/0027

(57) ABSTRACT

A system for generating current on a cart comprises a plurality of transmitting induction coils disposed below a surface. The plurality of transmitting induction coils is connected in an electrical circuit powered by mains power. Each transmitting induction coil generates an alternating electromagnetic field when powered by the mains power. A cart has a bottom area and a receiving induction coil coupled to the bottom area. The receiving induction coil generates an electrical current when approximately aligned with a given transmitting induction coil of the plurality of transmitting induction coils and is disposed within the alternating electromagnetic field generated by that given transmitting induction coil.

### RELATED APPLICATION

This application claims the benefit of and priority to co-pending U.S. Provisional Application No. 62/612,485 titled “Methods and Apparatuses for Powering Systems onboard Carts,” filed on Dec. 31, 2017, the entirety of which provisional application is incorporated by reference herein for all purposes.

### FIELD OF THE INVENTION

The invention relates to apparatuses and methodologies for recharging batteries and/or powering electronic devices on-board shopping carts or other type of carts.

### BACKGROUND

Electronic devices permeate society. Shopping carts, such as those used for shopping in brick-and-mortar retail stores and in warehouses, also have them for various purposes. Such on-cart devices require electric power. Powering the devices directly using a power cord limits the range of the cart to the length of the cord. On the other hand, swapping out batteries takes time and effort. Recharging rechargeable batteries while they remain on the carts with a power cord also requires time, effort, power cords and power outlets, and causes cart unavailability while the batteries recharge. Because of these shortcomings, industry is developing cordless, plug-less, and wireless charging systems.

### SUMMARY

All examples and features mentioned below can be combined in any technically feasible way.

In one aspect, the invention relates to a system for generating current on a cart. The system comprises a plurality of transmitting induction coils disposed below a surface. The transmission induction coils are connected in an electrical circuit powered by mains power. Each transmitting induction coil generates an alternating electromagnetic field when powered by the mains power. A cart has a bottom area and a receiving induction coil coupled to the bottom area. The receiving induction coil generates an electrical current when approximately aligned with a given transmitting induction coil of the plurality of transmitting induction coils and is disposed within the alternating electromagnetic field generated by that given transmitting induction coil.

In one embodiment, the system further comprises a ferrite plate embedded below the surface between each pair of neighboring transmitting induction coils to mitigate interference between neighboring electromagnetic fields.

The receiving induction coil may have a resonant frequency that is substantially identical to a resonant frequency of each of the plurality of transmitting induction coils and engage in resonant inductive coupling with the given transmitting induction coil.

The bottom area of the cart may have a plurality of receiver induction coils to enhance likelihood of one of the receiver induction coils aligning with one of the plurality of transmitter induction coils when the cart sits above the surface under which the plurality of transmitting induction coils are disposed. Neighboring receiver induction coils may overlap each other.

The system may further comprise a plurality of carts, each cart having a bottom area and a receiving induction coil coupled to that bottom area. The plurality of carts can be nested into one another to form a chain of carts. The receiving induction coil of each cart in the chain of carts generates an electrical current when that receiving induction coil is approximately aligned with one of the plurality of transmitting induction coils and is within the alternating electromagnetic field generated by that transmitting induction coil, thereby transferring power to the plurality of carts simultaneously.

In another aspect, the invention relates to a system for generating current on a cart. The system comprises a counter and a transmitting coil embedded in the counter. The transmitting coil is capable of emitting electromagnetic waves. The system further comprises a cart having a side and a receiving coil coupled to the side. The receiving coil is capable of receiving and converting electromagnetic waves into an electrical current when approximately aligned with the transmitting coil embedded in the counter and within range of the electromagnetic waves transmitted by the transmitting coil.

The transmitting and receiving coils may be radiofrequency (RF) coils or induction coils. The receiving coil may have a resonant frequency that is substantially identical to a resonant frequency of the transmitting coil and may engage in resonant inductive coupling with the transmitting coil.

The transmitting coil may emit the electromagnetic waves in response to user command. The cart may include an electronic device that is powered by the generated electrical current, and the powered electronic device wirelessly transmits information when powered by the electrical current.

In another aspect, the invention relates to a system for providing power to a cart comprising a first electrically conductive rail disposed on a floor surface and a second electrically conductive rail connected to a positive terminal of the mains power. The first electrically conductive rail is connected to a negative terminal of mains power. The system further comprises a cart having first and second electrically conductive members, an electrically conductive path between the first and second electrically conductive members, and a device disposed in the electrically conductive path. The first electrically conductive member makes electrically conductive contact with the first rail on the floor surface simultaneously with the second electrically conductive member making electrically conductive contact with the second rail to complete an electrical circuit and cause current to flow through the electrically conductive path to the device.

In one embodiment, the second electrically conductive rail is disposed on the floor surface and spaced apart from the first electrically conductive rail. An insulating strip may be disposed between the first and second electrically conductive rails on the floor surface. The cart may comprise a pair of wheels joined by an axle with an electrically conductive component, and the first electrically conductive member that makes electrically conductive contact with the first rail on the floor surface may be one of the pair of wheels and the second electrically conductive member that makes electrically conductive contact with the second rail may be the other of the pair of wheels, and the electrically conductive path between the first and second electrically conductive members may traverse the electrically conductive component of the axle. The first and second electrically conductive members may be metallic brushes that extend downwards from the cart to contact the electrically conductive rails.

The system may further comprise a cart corral with a pair of retainer railings spaced apart to closely receive the cart therebetween. One of the retainer railings may comprise the second electrically conductive rail, and the second electrically conductive member of the cart may be a metallic protrusion from a side of the cart.

In another aspect, the invention relates to a system for generating power on a cart comprising a cart corral having a pair of retainer railings spaced apart to closely receive the cart therebetween. One of the retainer railings has a bank of lights mounted thereon facing an interior of the cart corral. The system further comprises a cart having a side and one or more photovoltaic cells coupled to the side facing away from the cart. The one or more photovoltaic cells face the bank of lights when the cart is within the cart corral to absorb the light shined by the bank of lights.

In yet another aspect, the invention relates to a system for generating power on a cart comprising a cart having a frame resting on a plurality of wheels. Each wheel has a dynamo hub with a central rotor surrounded by a plurality of stators comprised of armature windings. Each stator produces a magnetic field. The rotor generates current when the wheels rotate by passing through the magnetic fields produced by the plurality of stators. The system further comprises a battery or device disposed on the cart. The battery or device is configured to receive the current generated by the rotation of the wheels.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is illustrated in various figures is represented by a like numeral. For purposes of clarity, not every component may be labeled in every figure. In the figures:

FIG. 1 is a raised view of an embodiment of a charging system, integrated into flooring, for transferring power by induction to a rechargeable battery and/or electronics on a cart;

FIG. 2 is a top view of an embodiment of a cart adapted to cooperate with the charging system of FIG. 1;

FIG. 3 is a diagram illustrating a process of an inductive power transfer between a paired primary transmitting induction coil and a secondary receiving induction coil in the charging system of FIG. 1;

FIG. 4A is a side view of a cart corral designed to recharge batteries or other electronics onboard a shopping cart;

FIG. 4B is a side view of the embodiment of the cart corral of FIG. 4A, with a plateau area in a middle region of the cart corral;

FIG. 5 is a top view of an embodiment of a power-transfer system that operates to activate an electronic circuit, device, or system on a shopping cart for an instance using pulse charging;

FIG. 6 is a transparent side-view of a checkout counter in the power-transfer system of FIG. 5, with a transmitting coil embedded in a side panel of the counter and a receiving coil in the side of the shopping cart;

FIG. 7 is a side-view of another embodiment of a charging system for charging batteries or powering electronics on a shopping cart, this embodiment employing light energy, absorbed either from the sun or from an artificial light source;

FIG. 8 is a top-view of another embodiment of a charging system for charging batteries or powering electronics on a shopping cart, this embodiment employing power strips on the flooring of a cart corral; and

FIG. 9 is a side view of an embodiment of a shopping cart wheel adapted to convert mechanical energy into electricity that can be used to charge batteries or directly power electronics on a shopping cart.

### DETAILED DESCRIPTION

Systems described herein, for recharging batteries and powering electronic devices onboard shopping carts, operate on the general principle that two magnetic fields in proximity to one another tend to align; opposing, they push away; both the pushing away and the pulling into alignment generates a force (flux) which can be captured and converted into electricity. There are several ways to induce a magnetic field capable of generating electric power using this principle. One way to induce a magnetic field is to pass current through a coil of wire. If two coils with current passing through them are in proximity to each other, the respective magnetic fields that are generated tend to align themselves. If the two coils are between 0 and 180 degrees out of alignment, this tendency may create a torque between the two coils.

Induction battery chargers use alternating electric current from power mains to cause a primary induction coil to create an alternating electromagnetic field. A secondary, receiving induction coil resides on the portable device, which is, for the embodiments described herein, the shopping cart. The receiving coil in the cart takes power from the electromagnetic field and converts it into electric current to charge the on-cart battery and/or power on-cart electronic devices. The two induction coils in proximity combine to form an electrical transformer.

Because the strength of the flux drops rapidly with distance (obeying an inverse square law), and there is some inefficiency with power transfer through air, the primary (transmitting) and secondary (receiving) coils should be as close to each other as possible. Induction charging across an air gap of several inches has an efficiency ratio of only a few percent, meaning 97% or 98% of the charge would not be received by the secondary coil on the cart. Shopping carts, however, need to have several inches of clearance between the bottom of the cart and the ground to clear door jambs at store entrances and, potentially, snow, ice chunks, rocks, and other stray objects in the parking lot. To improve power transfer across this clearance, the inductive charging systems described herein can use resonant inductive coupling.

Although described predominantly with respect to shopping carts, the principles described herein apply also to powering golf carts, electric wheelchairs, and other carting devices that require power.

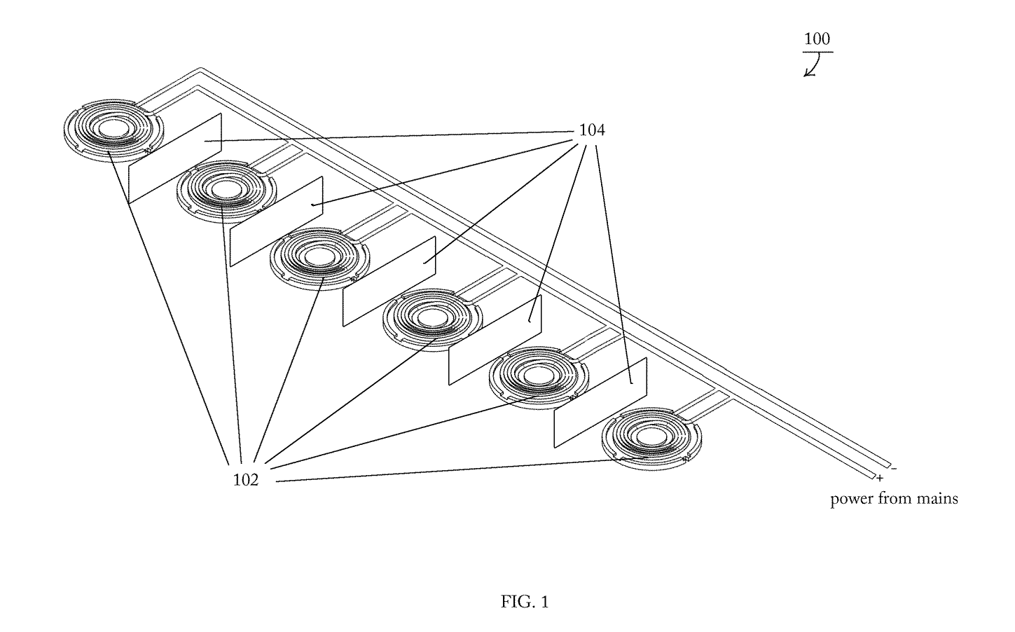

FIG. 1 shows an embodiment of a charging system 100 for transferring power by induction to a rechargeable battery and/or electronics embedded on a shopping cart. The charging system (or power-transfer system) 100 includes a plurality of underground primary (transmitting) induction coils 102 connected in an electrical series circuit to a mains power source (not shown). Mains power is the general-purpose alternating current (AC) electric power supply and is also known as household power or electricity, wall power, line power, AC power, grid power, city power, street power, and domestic power. The primary coils 102 get power in alternating current form from this mains power or another external power source.

In an alternative embodiment, the primary induction coils 102 are connected to the mains power in parallel circuits, each the primary induction coil 102 being in a separate circuit, so that a single faulty primary induction coil does not cause all coils to fail to operate properly, as a single point of failure might if all primary induction coils are connected in series. Another embodiment can have multiple parallel circuits of primary induction coils, with one or more of the parallel circuits having multiple primary induction coils connected in series.

In this embodiment, each primary induction coil 102 has a circular shape. Current from mains power enters one end of the coil and exits through its opposite end before passing to the next coil in the series (if any). Although multiple primary induction coils 102 are described, the charging system can have as few as one primary induction coil. A ferrite plate 104 is disposed vertically between each pair of neighboring induction coils 102 to act as a filter that prevents interference (magnetic field scatter) between the neighboring coils. The primary, transmitting induction coils 102 and ferrite plate filters 104 are enclosed in the flooring or substrate, or other built structure, just below the flooring surface.

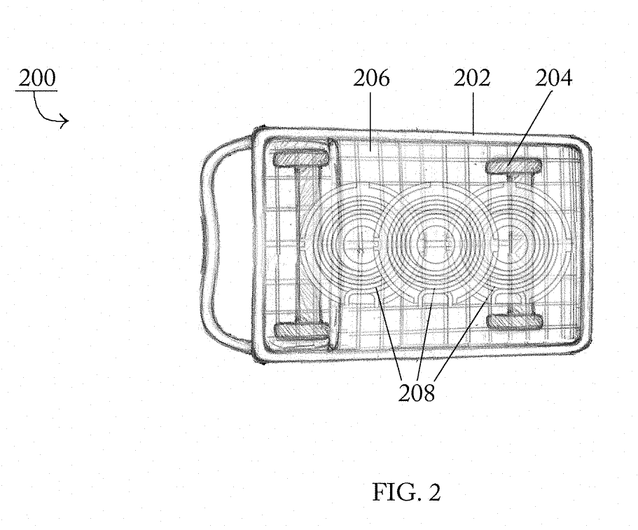

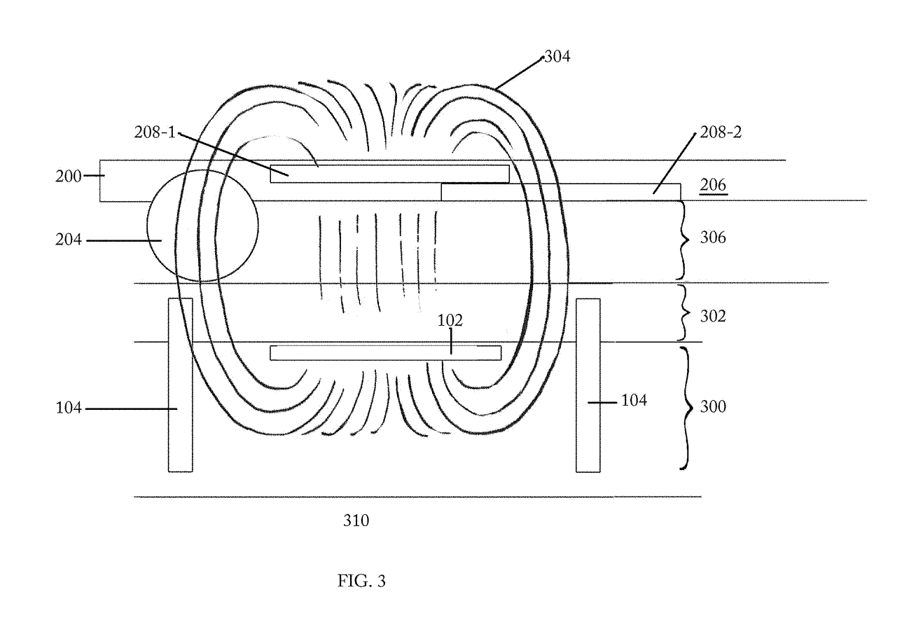

FIG. 2 shows a top view of an embodiment of a shopping cart 200 having a frame 202 on wheels 204, a shelf 206 proximate to and above the wheels, and a plurality of overlapping secondary (receiving) induction coils 208 built into or affixed to the shelf 206. For carts not having a shelf, the induction coils 208 can be built into or affixed to another bottom area of the cart, for example, the underside of the basket 209. The orientation of the secondary induction coils 208 substantially matches the orientation of the primary induction coils embedded in the flooring (FIG. 1). Each of the secondary induction coils 208 is connected to a rechargeable battery and/or electronics (not shown) embedded on the cart. The secondary induction coils 208 can be connected in series or in parallel. In one embodiment, the size and shape of each secondary induction coil 208 are designed to substantially match those of the primary induction coil 102 (FIG. 1), for purposes of enhancing the inductive power transfer from the primary induction coil to the secondary induction coil by resonant inductive coupling (described further in connection with FIG. 3). As one example, the coils have a 14″ diameter. Having multiple receiver coils placed on the cart in a similar lateral arrangement but offset longitudinally (from cart front to cart rear) facilitates the power transfer; it is anticipated that a single secondary receiving coil on the cart may not exactly align with a primary transmitting coil underground, and thus having multiple longitudinally offset coils on the cart will allow the power to transfer to the cart coil 208 that is most closely aligned to an transmitting coil 102. In another embodiment, the secondary induction coils 208 do not overlap, and although multiple secondary induction coils 208 are described, the cart 200 can have as few as one secondary receiving induction coil without departing from the principles described herein.

FIG. 3 illustrates inductive power transfer between primary transmitting induction coil 102 and a closely aligned secondary receiving induction coil 208-1. The transmitting induction coil 102 resides in a substrate layer 300 just below a cement flooring 302. The flooring 302 can be made of other materials, for example, tiling and carpeting, without departing from the principles described herein. The substrate layer 300 sits on a subsoil base 310. Vertically disposed ferrite plates 104, one on each side of the transmitting induction coil 102, bound the magnetic flux 304 produced by the coil 102 between them. Immediately above the transmitting induction coil 102 is the shopping cart 200 having the overlapping secondary (receiving) induction coils 208 built into the shelf 206, the wheels 204 of the cart sitting on the cement flooring. Overlapping secondary induction coils 208 improve the chances of a close alignment between one of the secondary induction coils 208 and one of the primary induction coils 102.

A gap 306 separates the bottom area of cart 200 with the secondary induction coils 208 and the surface of the cement flooring. A total air gap of several inches, comprised of the cement layer 302, the gap 306, and a portion of the shelf 206 of the cart 200, separates the induction coils 208 in the cart 200 from the underground induction coils 102. Ideally, this total air gap is as small as possible.

In one embodiment, the power transfer from the primary transmitting coil 102 to the secondary receiving coil 208-1 occurs through resonant inductive coupling. To achieve resonant inductive coupling, the secondary receiving coil 208 that is disposed within the oscillating magnetic field produced by the transmitting coil 102 operates at or near the identical resonant frequency of the primary transmitting coil (the distributed capacitance, resistance, and inductance of the coils 102, 208 determine this resonant frequency). The oscillating magnetic field generated by the primary transmitting coil induces a current in the secondary receiving coil, and the resonance between the coils 102, 208 increases the inductive coupling to a degree that achieves power transfer across greater distances than would be otherwise achievable without such resonance. Further, resonant inductive coupling is tolerant of less than full alignment between the transmitting and receiving coils and may enable a single transmitting coil to transfer power to multiple receiving coils. In addition, the orientation of the receiving coil need not be fully matched to that of the transmitting coil to achieve power transfer from resonant inductive coupling, provided the cross-section of the receiving coil presented to the transmitting coil is large enough to absorb more energy than the transmitting coil expends.

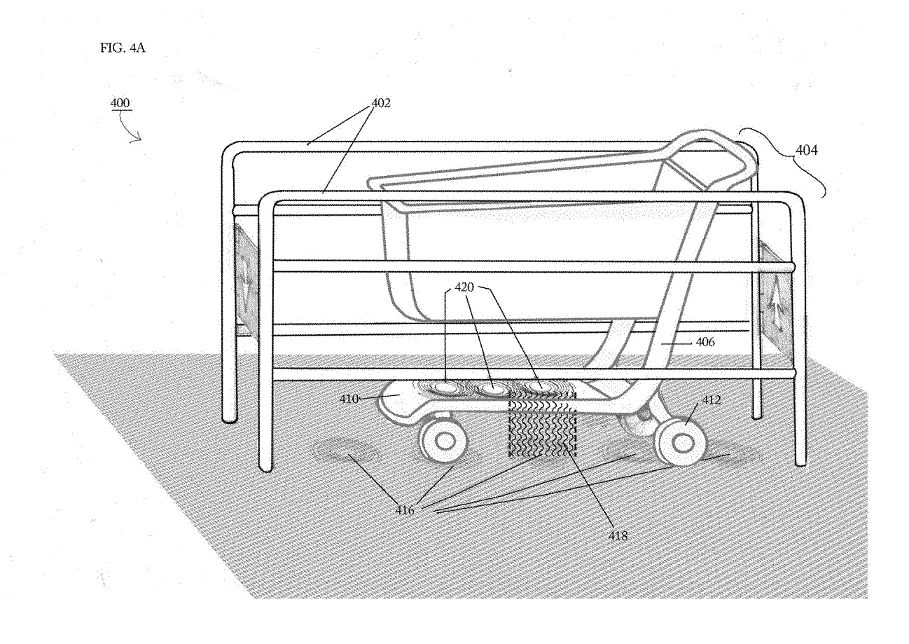

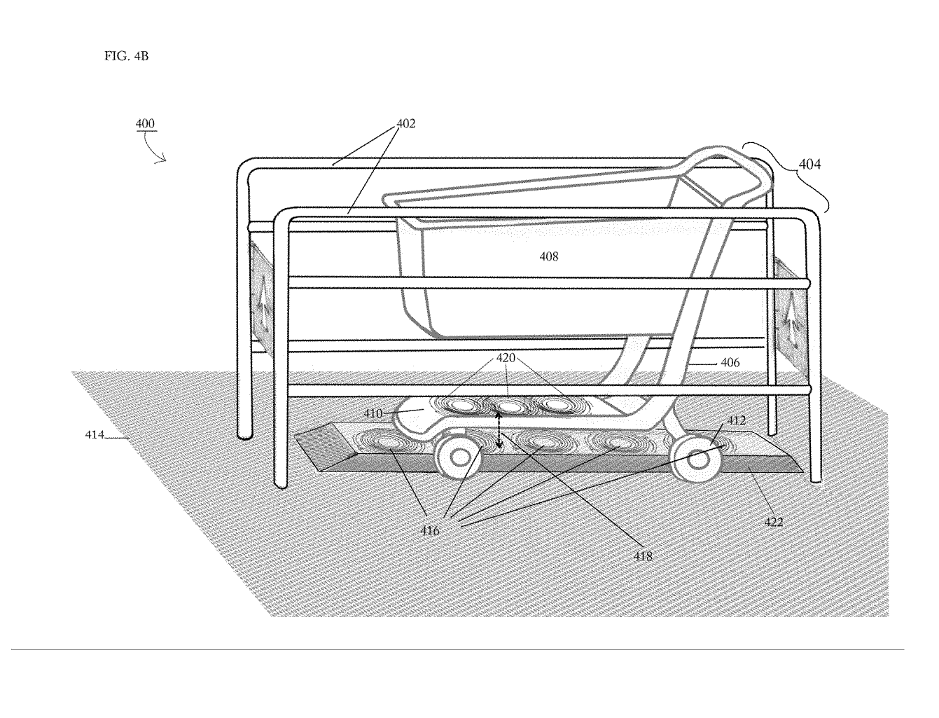

FIG. 4A shows an embodiment of a cart corral 400 built to recharge batteries or other electronics onboard a shopping cart, in accordance with the aforementioned principles. Cart corrals are also known as parking stalls, shopping cart returns, and carriage returns. The cart corral 400 includes a pair of parallel railings 402 spaced apart to closely receive the width of a shopping cart 404. The pair of parallel railings 402 define a channel in which shopping carts are placed in the corral when not in use. The shopping cart has a frame 406 that supports a basket 408, and a lower shelf 410 riding on wheels 412. Built into the lower shelf 410 are a plurality of overlapping receiving coils 420 (in this example, three such coils). The cart corral 400 sits above flooring 414 embedded with a series of underground transmitting coils 416 (in this example, five such coils), in line (or nearly in line, e.g., a zigzag) within the channel and connected in an electrical circuit to a power source (not shown). The location of the transmitting coils 416 is approximately midway in the channel between the parallel railings 402, where shopping carts reside within the corral 400. Ferrite plates (not shown) separate neighboring transmitting coils 416 to prevent magnetic interference between the transmitting coils.

In one embodiment, the width of the cart corral 400 is just wide enough to receive the widest part of the cart, thus ensuring that the cart or nested carts will be centered in the passageway of the cart corral, thereby optimizing the chances that the cart will be parked such that the receiving coils 420 are directly over the row of transmitting coils 416, and thus optimizing lateral alignment and power transfer therebetween.

As shown, the shopping cart 404 is within the cart corral 404, and at least one of the receiving coils 420 is aligned with one of the transmitting coils 416. The magnetic field 418 produced by the aligned transmitting coil 416 induces a current in the aligned receiving coil 420 (e.g., by resonant inductive coupling). This current operates to charge or operate any onboard battery or electronics on the cart. Although only one shopping cart is described, multiple shopping carts can be charged simultaneously when nested together in the channel of the corral, wherein each shopping cart has at least one inductive power collector (i.e., secondary receiving induction coil).

Although the channel of the cart corral 400 accommodates just one chain of nested carts for simultaneous charging, other embodiments of cart corrals can be wide enough and configured with multiple lines of transmitting induction coils to charge two or more chains of nested carts simultaneously.

In other embodiments, the transmitting coils are embodied in the parallel rails 402, or in side panels of the corral 400, or in a hood (not shown) over the corral. In such embodiments, the receiving coils are integrated into the shopping cart at locations designed to achieve alignment with the locations of the transmitting coils.

A cart corral 400 illustrates one example of a channel within which or through which a shopping cart sits or passes. Other examples of channels include cash register checkout lanes or narrow aisles. When configured with transmitting induction coils, these other types of channels can present opportunities to charge or power a battery or an electronic device onboard a shopping cart configured with a receiving induction coil, without wires or other physical contact methods.

Advantageously, the power transfer system has no exposed charging parts; though transmitting and receiving coils need to be in the same electromagnetic field, they can be encased, such as in plastic or under cement, for an unobtrusive, non-visible interface. Additionally, recharging of the cart batteries requires only the push of the cart or line of nested carts into the channel, and power transfers from the primary induction coil(s) fixed in the infrastructure to the secondary coil(s) on board the cart(s) without any further effort. Recharging batteries or powering electronics on a shopping cart requires no change in shopper or employee behavior, except that the cart needs to be returned to the corral for charging.

Power loss still occurs during inductive coupling. FIG. 4B shows an embodiment of the cart corral 400 of FIG. 4A with an added plateau area 422 in a middle region of the cart corral. Guide rails 402 on both sides narrowly channel the carts into a straight line. This narrow channel induces alignment with respect to other carts, making any nested line of carts straight. It also causes tight alignment with the row of transmitting inductive coils underneath the carts. Raising the area 422 of the floor of the cart corral between the cart wheels further promotes alignment and allows the transmitting induction coils to be raised, too, thereby reducing the gap between transmitting and receiving coils and improving transfer efficiency.

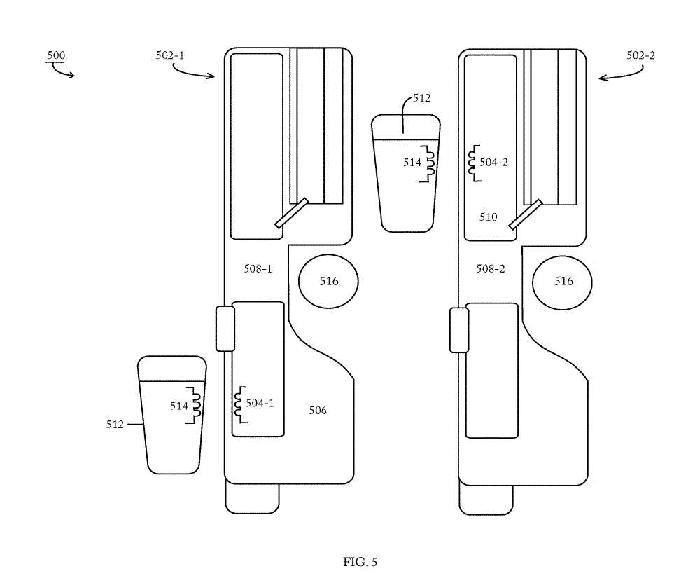

FIG. 5 shows an embodiment of a power-transfer system 500 that operates to activate an electronic circuit, device, or system on the shopping cart, while the cart is momentarily motionless, using pulse charging. The current induced by the pulse charging is sufficient to charge a battery or operate an electronic device long enough for the electronic device to execute a predetermined operation. For example, the power-transfer system 500 includes two pulse-charging stations 502-1, 502-2 (generally, 502) incorporated in checkout lanes of a store. The first pulse-charging station 502-1 has a built-in transmitting coil 504-1 at or near the bagging area 506 of the checkout counter 508-1. The second pulse-charging station 502-2 has a built-in transmitting coil 504-2 at or near the conveyor belt area 510 (below the belt) of the checkout counter 508-2. The pulse charger (i.e., transmitting coil) can be located anywhere along the checkout channel. Shopping carts 512 are equipped with a receiving coil 514, preferably disposed on that side of the cart that comes within operational proximity of a transmitting coil 504. The receiving coil 514 can be a passive radiofrequency (RF) coil or a receiving induction coil (the particular type matches the type of the transmitting coil). In one embodiment, wherein the receiving and transmitting coils are induction coils, the receiving coil operates at or near the identical resonant frequency of the transmitting coil, and the transmitting coil induces a current in the receiving coil by resonant inductive coupling.

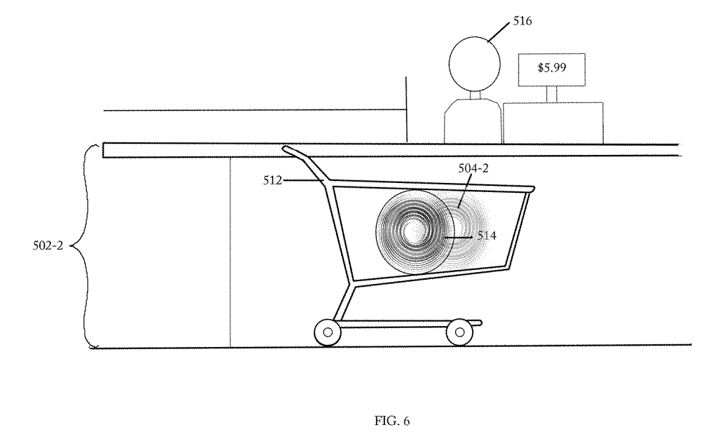

FIG. 6 shows a transparent side-view of the checkout counter 502-2 with the transmitting coil 504-2 embedded in a side panel of the counter and the receiving coil 514 in the side of the shopping cart 512. While the cart sits beside the checkout counter, for example, as the shopper loads or waits to load items onto the conveyor belt or as the cashier 516 rings up purchases, the transmitting coil 504 can pulse, initiated either manually (e.g., by the cashier pressing a button) or automatically (e.g. by motion or cart detection). When the transmitting coil 504 is an RF transmitting coil, the pulse comprises an electromagnetic signal; when the transmitting coil 504 is a transmitting induction coil, the pulse comprises an alternating magnetic field. The pulse can activate a passive radiofrequency (RF) coil (in the case where the transmitting coil is an RF transmitting coil) or a receiving induction coil (in the case where the transmitting coil is an transmitting induction coil), which would provide enough current for an electronic device on the cart to perform an operation. For example, consider that the cart has a built-in weight sensor for weighing items on the lower shelf of the cart. An electronic device on the cart, momentarily powered by the current, can read the scale and transmit the information to a receiver in the cashier's system. This information can alert the cashier (if any) to items remaining in the cart that may not have yet been added to a shopper's bill.

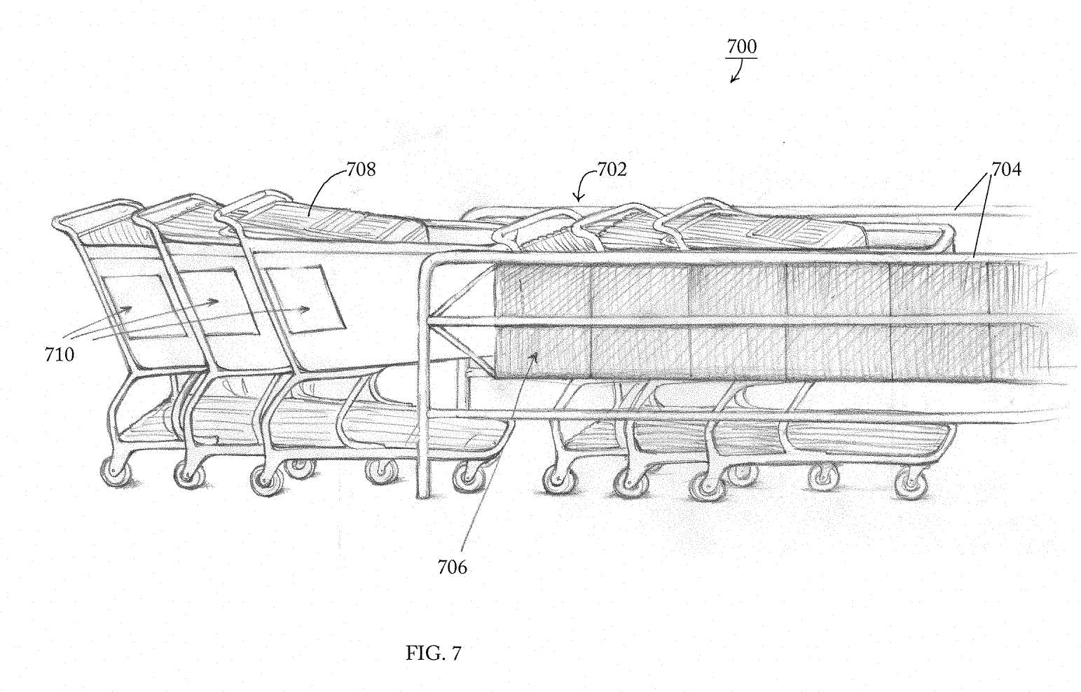

FIG. 7 shows another embodiment of a charging system 700 for charging batteries or powering electronics on a shopping cart, this embodiment employing light energy, absorbed either from the sun or from an artificial light source. To absorb the light, a shopping cart is equipped with one or more solar panels (i.e., photovoltaic cells). These photovoltaic cells convert visible light into direct current. A solar panel, or series of solar panels, having approximately one square foot of surface area can absorb enough light and generate enough power to charge batteries and/or run electronics on the cart. The amount of surface area and the amount of energy required varies with the efficiency of the solar panels and the power requirements of the onboard electronics. The solar panel, or series of solar panels, can be installed on the cart to face skywards, to absorb light from the sun, or to face sideward or downwards, to absorb light from a known artificial light source, such as a strip of lights facing upwards from the floor or bank of lights facing sideward from a side railing.

The charging system 700 shown in FIG. 7 is implemented at a cart corral 702. The cart corral 702 includes a pair of parallel railings 704 spaced apart to closely receive the width of a shopping cart 706 therebetween. The length of the cart corral 702 permits for multiple nested carts to be parked between the railings. One side of the cart corral 702 has a bank of lights 706 facing inwards into the corral. The bank of lights 706 extends for most of the length of the corral. Power to these banks of lights comes from mains electric power (not shown). Shopping carts 708 configured for this charging system 700 have photovoltaic cells 710 on the cart side that faces the banks of light when the cart is motionless in the corral. Other embodiments have banks of lights on both sides of the cart corral and/or photovoltaic cells on both sides of the cart to allow the cart to enter the corral from either of its ends.

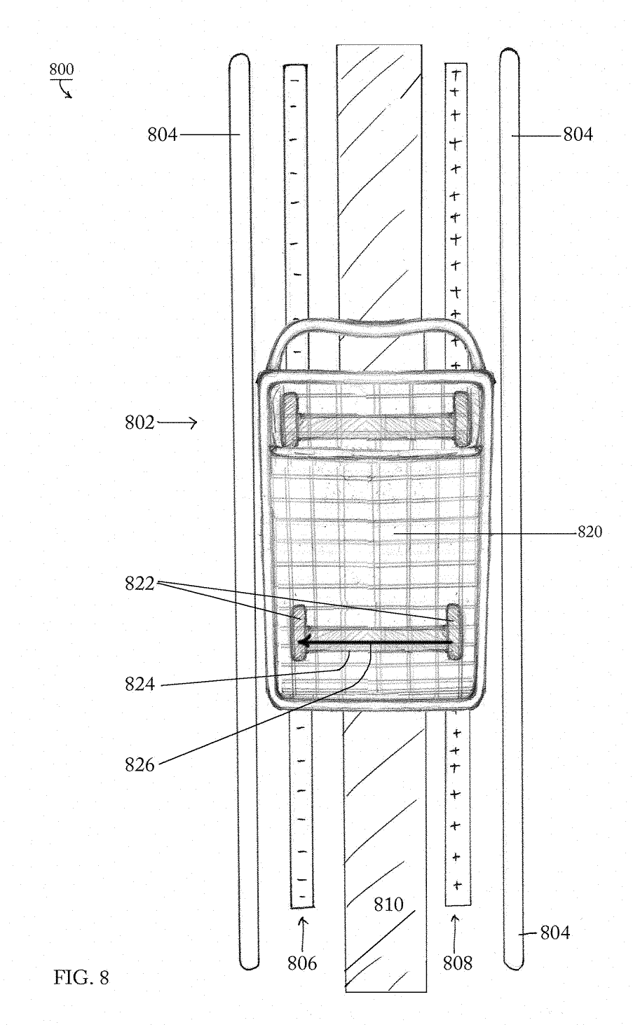

FIG. 8 shows another embodiment of a charging system 800 for charging batteries or powering electronics on a shopping cart 820. This embodiment employs direct electrical charging through an electrically conductive brush or brushes or other electrically conductive part or parts that protrude from the cart. The charging system 800 uses a cart corral 802 with a pair of parallel side rails 804 that act as side barriers to confine a cart laterally therebetween. On the flooring between the side rails 804 are two electrically conductive rails or strips: a negative strip 806 and a positive strip 808, each running substantially the full length of the cart corral. Both strips 806, 808 are electrically connected to the mains AC power supply; the negative strip 806 to the mains negative terminal; the positive strip 808 to the mains positive terminal. Between the two strips 806, 808 is an insulating strip 810, also running substantially the full length of the cart corral, to prevent current from leaking between the positive and negative strips. The insulating strip 810 can be raised to mitigate the chance a fallen item can lay across both negative and positive strips and cause an electric short.

In this embodiment, the locations of the positive and negative strips are designed to align with the placement of the wheels of the cart when the cart sits motionless in the cart corral. In addition, two wheels 822 of the cart (e.g., the two front wheels or the two rear wheels) and the axle 824 or a part of the axle 824 between the pair are electrically conductive. When the electrically conductive pair of wheels contact both the positive strip and the negative strip simultaneously, the electrical circuit closes and current flows. The path 826 of the current travels from the mains power supply to the positive strip, into one wheel, through the axle, out through the other wheel, into the negative strip, and back to the mains power supply. To be charged or powered by this current, the battery and/or electronic device resides in the path of the current. In this example, the battery could reside in the axle between the wheels. The battery or electronic device may reside elsewhere on the cart, for example, under the basket, provided the circuit is so configured that when the current enters one wheel and exits another, the battery or electronic device is directly in the path of the current.

Rather than use the wheels of the cart as points of contact with the negative and positive strips, electrically conductive brushes or other physical electrically conductive features that protrude from the cart can be employed. The circuit closes when one brush (or other contact point) contacts the positive strip on the floor below the cart while another brush (or contact point) contacts the negative strip also on the floor below the cart. The path of the current taken between these two brushes can be designed to traverse an electrically conductive feature of the cart (other than the wheel axle) that charges the battery or powers onboard electronics.

In another embodiment, the positive strip is embodied in a side rail of the cart corral, and the cart has an electrically conductive brush that protrudes from its side at the proper height to make electrically conductive contact with this positive strip. The negative strip is on the floor. Current flows when the side brush of the cart touches the positive strip on the side rail of the cart corral simultaneously with a second brush (or conductive wheel) on the cart contacting the negative strip below the cart (there being an electrically conductive path between the two brushes). Similarly, the negative strip can be embodied in a side rail of the cart corral (with the positive strip on the floor or embodied in the side rail opposite that of the negative strip).

Although the term brush is used herein with reference to a cart feature used to make electrical contact, such contact does not have to be made through a physical brush with multiple bristles; electrically conductive touching or contact is made through any two electrically conductive parts. Single metal points of contact, a point of a metal wire, or a metal strip in the wheel, for example, can suffice to touch a conductive strip in the side of the cart corral or embedded on the floor.

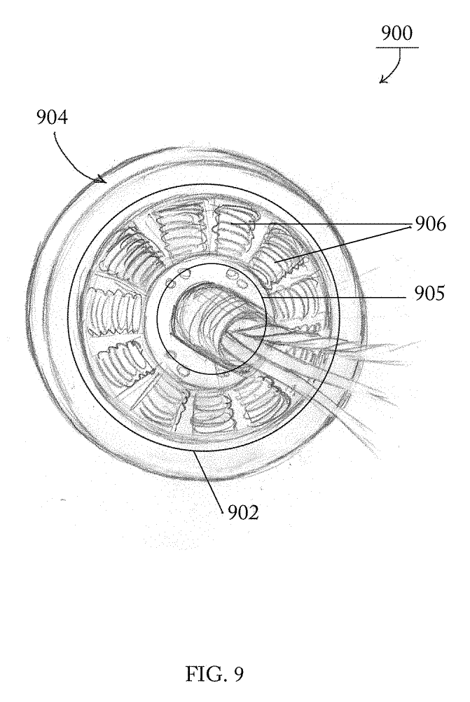

FIG. 9 shows another embodiment of a charging system 900 for charging batteries or powering electronics on a shopping cart. This embodiment capitalizes on the energy expended by shoppers as they traverse a store, pushing their shopping carts in front of them. By adding a small dynamo 902 to one or more wheels 904, the charging system 900 transforms the mechanical energy of the rotating wheels into electrical energy, used either to power the onboard electronics directly or to charge a battery. The dynamo captures the force expended when the cart is pushed; the permanent magnet rotor 905 is centrally located. Stators 906, commonly an iron core wound with copper wires, generate powerful magnetic fields. As the wheel turns, the rotor 905 cuts through the magnetic lines of flux generated by the circling stators 906, generating electric current which is captured by the armature windings. A rechargeable battery on the cart stores the electrical energy generated, rather than having the power directly expended as is typical in dynamo-electric mechanisms. As the amount of energy generated by a single wheel may not be enough to power most electronics on the cart, one embodiment captures the energy from at least two, and preferably all, the wheels on the cart.

As will be appreciated by one skilled in the art, aspects of the present invention may be embodied as a system, method, and apparatus. Thus, some aspects of the present invention may be embodied entirely in hardware, entirely in software (including, but not limited to, firmware, program code, resident software, microcode), or in a combination of hardware and software.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Embodiments of the methods and apparatuses discussed herein are not limited in application to the details of construction and the arrangement of components set forth in the foregoing description or illustrated in the accompanying drawings. The methods and apparatuses are capable of implementation in other embodiments and of being practiced or of being carried out in various ways. Examples of specific implementations are provided herein for illustrative purposes only and are not intended to be limiting. References to “one embodiment” or “an embodiment” or “another embodiment” means that a feature, structure or characteristic described in connection with the embodiment is included in at least one embodiment described herein. References to one embodiment within the specification do not necessarily all refer to the same embodiment. The features illustrated or described in connection with one exemplary embodiment may be combined with the features of other embodiments.

Also, the phraseology and terminology used herein is for the purpose of description and should not be regarded as limiting. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all the described terms. Any references to front and back, left and right, top and bottom, upper and lower, and vertical and horizontal are intended for convenience of description, not to limit the present systems and methods or their components to any one positional or spatial orientation. Accordingly, the foregoing description and drawings are by way of example only, and the scope of the invention should be determined from proper construction of the appended claims, and their equivalents.

What is claimed is:

1. A system for generating current on a cart comprising:
a plurality of transmitting induction coils disposed below a surface, the plurality of transmitting induction coils being connected in an electrical circuit powered by mains power, each transmitting induction coil generating an alternating electromagnetic field when powered by the mains power; and
a cart having a bottom area and a receiving induction coil coupled to the bottom area, the receiving induction coil generating an electrical current when approximately aligned with a given transmitting induction coil of the plurality of transmitting induction coils and is disposed within the alternating electromagnetic field generated by that given transmitting induction coil.

2. The system of claim 1, further comprising a ferrite plate embedded below the surface between each pair of neighboring transmitting induction coils to mitigate interference between neighboring electromagnetic fields.

3. The system of claim 1, wherein the receiving induction coil has a resonant frequency that is substantially identical to a resonant frequency of each of the plurality of transmitting induction coils and engages in resonant inductive coupling with the given transmitting induction coil.

4. The system of claim 1, wherein the bottom area of the cart has a plurality of receiver induction coils to enhance likelihood of one of the receiver induction coils aligning with one of the plurality of transmitter induction coils when the cart sits above the surface under which the plurality of transmitting induction coils are disposed.

5. The system of claim 4, wherein neighboring receiver induction coils overlap each other.

6. The system of claim 1, further comprising a plurality of carts each having a bottom area and a receiving induction coil coupled to that bottom area, the plurality of carts being nested into one another to form a chain of carts, the receiving induction coil of each cart in the chain of carts generating an electrical current when that receiving induction coil is approximately aligned with one of the plurality of transmitting induction coils and is within the alternating electromagnetic field generated by that transmitting induction coil, thereby transferring power to the plurality of carts simultaneously.

7. A system for generating current on a cart comprising:
a counter;
a transmitting coil embedded in the counter, the transmitting coil capable of emitting electromagnetic waves; and
a cart having a side and a receiving coil coupled to the side, the receiving coil capable of receiving and converting electromagnetic waves into an electrical current when approximately aligned with the transmitting coil embedded in the counter and within range of the electromagnetic waves transmitted by the transmitting coil.

8. The system of claim 7, wherein the transmitting and receiving coils are radiofrequency (RF) coils.

9. The system of claim 7, wherein the transmitting and receiving coils are induction coils.

10. The system of claim 7, wherein the receiving coil has a resonant frequency that is substantially identical to a resonant frequency of the transmitting coil and engages in resonant inductive coupling with the transmitting coil.

11. The system of claim 7, wherein the transmitting coil emits the electromagnetic waves in response to user command.

12. The system of claim 7, wherein the cart includes an electronic device that is powered by the generated electrical current, and wherein the powered electronic device wirelessly transmits information when powered by the electrical current.

13. A system for providing power to a cart comprising:
a first electrically conductive rail disposed on a floor surface, the electrically conductive rail being connected to a negative terminal of mains power;
a second electrically conductive rail connected to a positive terminal of the mains power;
a cart having first and second electrically conductive members, an electrically conductive path between the first and second electrically conductive members, and a device disposed in the electrically conductive path, the first electrically conductive member making electrically conductive contact with the first rail on the floor surface simultaneously with the second electrically conductive member making electrically conductive contact with the second rail to complete an electrical circuit and cause current to flow through the electrically conductive path to the device.

14. The system of claim 13, wherein the second electrically conductive rail is disposed on the floor surface and spaced apart from the first electrically conductive rail.

15. The system of claim 14, further comprising an insulating strip disposed between the first and second electrically conductive rails on the floor surface.

16. The system of claim 14, wherein the cart comprises a pair of wheels joined by an axle with an electrically conductive component and wherein the first electrically conductive member that makes electrically conductive contact with the first rail on the floor surface is one of the pair of wheels and the second electrically conductive member that makes electrically conductive contact with the second rail is the other of the pair of wheels, and the electrically conductive path between the first and second electrically conductive members traverses the electrically conductive component of the axle.

17. The system of claim 14, wherein the first and second electrically conductive members are metallic brushes that extend downwards from the cart to contact the electrically conductive rails.

18. The system of claim 13, further comprising a cart corral with a pair of retainer railings spaced apart to closely receive the cart therebetween, wherein one of the retainer railings comprises the second electrically conductive rail, and the second electrically conductive member of the cart is a metallic protrusion from a side of the cart.

19. A system for generating power on a cart comprising:
a cart corral having a pair of retainer railings spaced apart to closely receive the cart therebetween, wherein one of the retainer railings having a bank of lights mounted thereon facing an interior of the cart corral; and
a cart having a side and one or more photovoltaic cells coupled to the side facing away from the cart, the one or more photovoltaic cells facing the bank of lights when the cart is within the cart corral to absorb the light shined by the bank of lights.

20. A system for generating power on a cart comprising:
a cart having a frame resting on a plurality of wheels, each wheel having a dynamo hub with a central rotor surrounded by a plurality of stators comprised of armature windings, each stator producing a magnetic field, the rotor generating current when the wheels rotate by passing through the magnetic fields produced by the plurality of stators; and
a battery or device disposed on the cart, the battery or device being configured to receive the current generated by the rotation of the wheels.
